(19) United States
(12) Patent Application Publication
(10) Pub. No.: US 2015/0058126 A1
(43) Pub. Date: Feb. 26, 2015

(54) MEDIA CONTENT TRANSACTION

(71) Applicant: KT Corporation, Seongnam-si (KR)

(72) Inventor: Kang-tae LEE, Goyang-si (KR)

(21) Appl. No.: 14/463,036

(22) Filed: Aug. 19, 2014

(30) Foreign Application Priority Data
Aug. 23, 2013 (KR) 10-2013-0100684

(51) Int. Cl. G06Q 30/02; H04L 29/06; A63F 13/61; H04L 12/26

(52) U.S. Cl. CPC G06Q 30/0262; H04L 43/08; H04L 67/42; A63F 13/61
USPC 705/14.59

(57) ABSTRACT

In one example embodiment, a user device includes a collector configured to collect data regarding usage history for media content associated with a user's account; an identifier configured to identify whether the respective media content is sleeping; and a scheduler configured to determine, if the media content is not identified as being sleeping, an amount of time until the respective media content may be identified as being sleeping, based on the usage history.

### TECHNICAL FIELD

The embodiments described herein pertain generally to a media content transaction.

### BACKGROUND

In recent years, based on increasing supply and demand for smart devices such as smart phones, tablet computer, etc, application marketplaces have made available various software applications and, in addition or in the alternative, items that may be purchased using some of those applications.

### SUMMARY

In one example embodiment, a user device may include a collector configured to collect data regarding usage history for media content associated with a user's account; an identifier configured to identify whether the respective media content is sleeping; and a scheduler configured to determine, if the media content is not identified as being sleeping, an amount of time until the respective media content may be identified as being sleeping, based on the usage history.

In another example embodiment, a server may include a receiver configured to receive, from a user device, a request to sell sleeping media content; a price manager configured to estimate a price for the sleeping media content; and a database configured to register the sleeping media content as used media content.

In yet another example embodiment, a system may include a user device configured to: collect data regarding usage history for game content, and identify whether the game content is sleeping based on the usage history. The system may also include a server configured to: receive, from the user device, a request to sell the sleeping game content, estimate a price for the sleeping game content, and register the sleeping game content as used game content.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent from the following detailed description. The use of the same reference numbers in different figures indicates similar or identical items.

FIG. 1 shows an example system in which a media content transaction may be implemented, in accordance with various embodiments described herein;

FIG. 2 shows an example user device by which at least portions of a media content transaction may be implemented, in accordance with various embodiments described herein;

FIG. 3 shows an example server by which at least portions of a media content transaction may be implemented, in accordance with various embodiments described herein;

FIG. 4 shows an example processing flow of operations by which at least portions of a media content transaction may be implemented, in accordance with various embodiments described herein;

FIG. 5 shows another example processing flow of operations by which at least portions of a media content transaction may be implemented, in accordance with various embodiments described herein;

FIG. 6 shows still another example processing flow of operations by which at least portions of a media content transaction may be implemented, in accordance with various embodiments described herein; and

FIG. 7 shows an example computing embodiment, by which any of the processes and sub-processes of a media content transaction may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

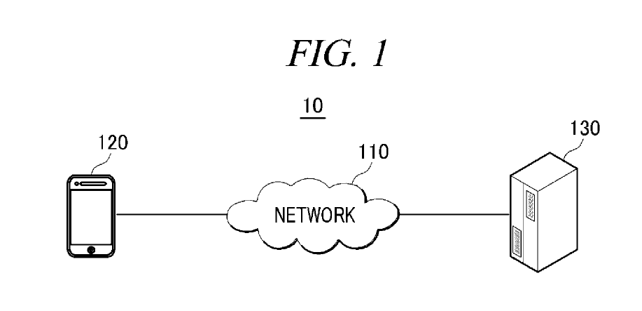

FIG. 1 shows an example system in which a media content transaction may be implemented, in accordance with various embodiments described herein. As depicted in FIG. 1, system 10 may include, at least, a user device 120 and a server 130. User device 120 and server 130 may be communicatively connected to each other via a network 110.

Network 110 may include, as non-limiting examples, a wireless network such as a mobile radio communication network including at least one of a 3rd generation (3G), 4^{th} generation (4G), or 5^{th} generation (5G) mobile telecommunications network, various other mobile telecommunications networks, a satellite network, WiBro (Wireless Broadband Internet), Mobile WiMAX (World Interoperability for Microwave Access), HSDPA (High Speed Downlink Packet Access), or the like.

User device 120 may refer to, as non-limiting examples, a notebook computer, a personal computer, a smart phone, a smart television, a digital camera, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and WiBro terminal.

In some embodiments, user device 120 may be configured to collect, from a database or a memory of user device 120, data regarding usage history for media content that is associated with a user's account that is authenticated on user device 120. For example, but not as a limitation, the data regarding usage history for media content may include at least one of a play history that may include dates and/or times on which the media content has been used or played on user device 120 or a user account associated with the owner and/or operator of user device 120, an amount of time that the media content has been used or played on user device 120 or a user account associated with the owner and/or operator of user device 120, the most recent date on which the media content was used or played on user device 120, or a number of times for the media content has been used or played on user device 120.

As referenced herein, non-limiting examples of the media content may include at least one of images, videos, music, apps, electronic book content, game currency, game characters, or game items associated with the game characters. In some embodiments, user device 120 has purchased user rights to use or play the media content from server 130 or a service provider.

As referenced herein, “sleeping media content” may refer to media content that has not been used on user device 120 or in connection with user account associated with the owner and/or operator of user device 120 for more than a first time period Tₚ₁ predetermined for that purpose.

As referenced herein, “hibernating media content” may refer to media content that may be imminently identified or classified as sleeping. Hibernating media content may refer to media content that has not been used on user device 120 or in connection with a user account associated with the owner and/or operator of user device 120 for more than a second predetermined time period Tₚ₂ that may be shorter than first predetermined time period Tₚ₁. Thus, the hibernating media content may be imminently identified or classified as sleeping if the hibernating media content is continuously not used for a period of time up to first predetermined time period Tₚ₁.

As referenced here, media content in a “normal operating mode” may refer to media content that is frequently used or has been recently used on user device 120 or in connection with a user account associated with the owner and/or operator of user device 120. The media content being in a “normal operating mode” has been used on user device 120 or in connection with a user account associated with the owner and/or operator of user device 120 within second predetermined time period Tₚ₂.

User device 120 may also be configured to analyze the collected data regarding usage history for media content. Thus, user device 120 may identify whether the media content is sleeping, hibernating or in normal operating mode based on the usage history for the media content. In some embodiments, user device 120 may identify the media content to be sleeping if the media content has not been used on user device 120 or in connection with a user account associated with the owner and/or operator of user device 120 for more than first time period Tₚ₁ predetermined for that purpose. For example, but not as a limitation, the predetermined time period Tₚ₁, which may be a setting made in connection with a user account associated with the owner and/or operator of user device 120, may be set to be, e.g., a month; and may be predefined and/or changeable by a user of user device 120.

Alternatively, user device 120 may identify the media content to be hibernating if the media content has not been used on user device 120 or in connection with a user account associated with the owner and/or operator of user device 120 for more than a second time period Tₚ₂ predetermined for that purpose. Further, user device 120 may be configured to analyze and/or check the usage history for the media content that is identified as hibernating media content at a first predetermined time interval Tᵢ₁. For example, but not as a limitation, user device 120 may check the usage history for the hibernating media content every 24 hours, and determine whether the hibernating media content has been used or not. User device 120 may further determine a remaining amount of time until the hibernating media content is deemed to be sleeping media content. If the hibernating media content has not been used for more than the first time period Tₚ₁, user device 120 may be configured to identify the hibernating media content to be sleeping media content. Further, user device 120 may be configured to analyze and/or check the usage history for the media content that is identified as normal media content at a second predetermined time interval Tᵢ₂, which may be longer than the first predetermined time interval Tᵢ₁. For example, but not as a limitation, user device 120 may be configured to check the usage history for the normal media content every 72 hours or once a week. User device 120 may be further configured to determine a remaining amount of time until the normal media content may be deemed to be sleeping media content.

In some embodiments, user device 120 may be configured to receive user input that may include at least one of a price for the identified sleeping media content or a sales format for the identified sleeping media content. For example, the input price for the identified sleeping media content may be a desired transaction price that is set by a user of user device 120. Further, as non-limiting examples, the sales format may include at least one of an auction, a direct transaction between another user device and server 130, a resale or refund transaction between server 130 and a service provider that provided and/or generated the sleeping media content, an exchange of the sleeping media content for other media content or reward points. In some embodiments, user device 120 may be configured to receive the user input from a user via a user interface that may be displayed on a display that is communicatively coupled to user device 120.

User device 120 may be configured to transmit, to server 130, an offer to sell the identified sleeping media content. The offer may include at least one of an input price for the identified sleeping media content and/or a desired sales format for the identified sleeping media content. Further, in some embodiments, the offer may include at least one of content information describing the sleeping media content, such as game currency, a game level, a game character or a game item; an identifier of user device 120; or user's account authenticated on user device 120.

In some embodiments, user device 120 may be configured to transmit the offer to sell the identified sleeping media content to server 130 automatically when user device 120 identifies or deems the media content to be sleeping.

Server 130 may refer to one or more servers, processing apparatuses, or computing devices hosted and/or supported by a service provider that may provide a service to implement media content transactions for end devices, including user device 120. As a non-limiting example of a feature of such service, server 130 may receive, from user device 120, a request to sell sleeping media content that is stored on user device 120 or is associated with a user account for an owner and/or operator of user device 120. As another non-limiting example of a feature of such service, the sleeping media content that is the subject of the request for the media content transaction may have gone unused for more than a predetermined time period on user device 120 or a user account associated with the owner and/or operator of user device 120. Server 130 may further execute a transaction for the requested sleeping media content, and transmit a result of the transaction to user device 120 or to an account of an owner and/or operator of user device 120.

Server 130 may be configured to receive the offer to sell the sleeping media content from user device 120. Server 130 may identify and/or classify the sleeping media content as media content that is being actively used or has been recently used. Further, server 130 may store the received content information in the database of server 130.

Server 130 may be configured to determine a price for the sleeping media content. In some embodiments, server 130 may be configured to identify the desired price included in the received offer as the price for the sleeping media content. In some other embodiments, server 130 may be configured to estimate the price for the sleeping media content based on the content information that is included in the received offer. For example, server 130 may be configured to estimate the price for sleeping game character based on at least one of game currency that the sleeping game character has, game items that are equipped with the sleeping game character, or a game level of the sleeping game character. Thus, in some embodiments, server 130 may determine a transaction price for the sleeping media content as the user's asking price (e.g., the desired price) itself. Alternatively, in some other embodiments, server 130 may calculate or estimate a transaction price for the sleeping media content based on the value of the content and/or the user's asking price. Further, in some embodiments, server 130 may transmit or inform the determined and/or estimated price to user device 120. If a user of user device 120 does not like the price, the user can cancel the request to sell the sleeping media content.

Server 130 may be further configured to determine a sales format for the sleeping media content, based on the desired sales format that is included in the received offer. Further, an instruction to execute the desired sales format may be transmitted to server 130 from user device 120, along with the offer.

Server 130 may be configured to sell the sleeping media content based on the determined or estimated price and the determined sales format. For example, server 130 may be configured to conduct a transaction between server 130 and another user device on behalf of the user, e.g., owner/operator of user device 120. Server 130 may transmit, to the other user device, user rights to use the sleeping media content, and receive, from the other user device, at least one of game currency, or reward points that correspond to the estimated price. As another example, server 130 may be configured to conduct a transaction between server 130 and a service provider that provides the sleeping media content on behalf of the user, e.g., owner/operator of user device 120.

Server 130 may be configured to return, to the service provider, user rights that are assigned to user device 120 or to a user account for an owner/operator of user device 120 to use the sleeping media content; and server 130 may be configured to receive, from the service provider, at least one of another media content, game currency, or reward points that correspond to the estimated price.

As another example, server 130 may be configured to conduct an auction to sell the sleeping media content between multiple user devices on behalf of the user, e.g., owner/operator of user device 120. For example, server 130 may execute well-known web or internet-based auction processes to sell the sleeping media content.

Server 130 may be configured to retrieve, from user device 120, user rights to use or play the sleeping media content when the sleeping media content is sold. Further, server 130 may be configured to transmit, to user device 120, a notification regarding a result of the sale of the sleeping media content and a reward corresponding to the estimated price. For example, the result may include an identifier of the sold media content and/or the executed sales format. Further, server 130 may be configured to transmit, to user device 120, cash, game currency, reward points or user rights for other media content as the reward of the transaction.

Thus, FIG. 1 shows an example system in which a media content transaction may be implemented, in accordance with various embodiments described herein.

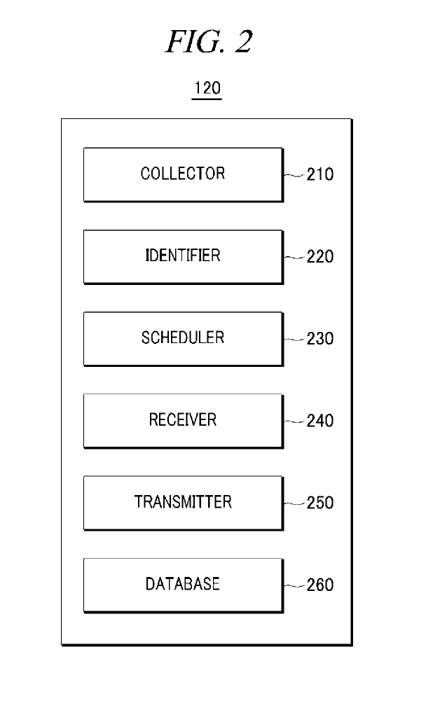

FIG. 2 shows an example user device by which at least portions of a media content transaction may be implemented, in accordance with various embodiments described herein. As depicted in FIG. 2, user device 120 may include a collector 210, an identifier 220, a scheduler 230, a receiver 240, a transmitter 250, and a database 260. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of collector 210, identifier 220, scheduler 230, receiver 240, transmitter 250, and database 260 may be included in an instance of an application hosted on user device 120.

Collector 210 may be configured to collect data regarding usage history for media content that is associated with a user's account that is authenticated on user device 120. For example, but not as a limitation, the usage history for media content may include at least one of a play history that may include dates and/or times on which the media content has been used or played, an amount of time that the media content has been used or played, the most recent date on which the media content was used or played, or a number of times for the media content has been used or played. As non-limiting examples, the media content may include at least one of images, videos, music, apps, electronic book content, game currency, game characters, or game items associated with the game characters.

Identifier 220 may be configured to analyze the collected data regarding the usage history for the media content. Thus, identifier 220 may identify whether the media content is sleeping, hibernating or in normal operating mode based on the usage history for the media content. In some embodiments, identifier 220 may identify the media content as being sleeping if the media content has not been used on user device 120 or in connection with a user account associated with the owner and/or operator of user device 120 for more than first time period Tₚ₁ predetermined for that purpose. For example, but not as a limitation, the first predetermined time period Tₚ₁ may be a month; and may be predefined and/or changeable by a user of user device 120. Further, if the media content is identified as not being sleeping, identifier 220 may identify whether the media content identified as not being sleeping is hibernating. Identifier 220 may identify the media content as hibernating if the media content has not been used on user device 120 or in connection with the user account associated with the owner and/or operator of user device 120 for more than second time period Tₚ₂ predetermined for that purpose. The second time period Tₚ₂ may be shorter than the first time period Tₚ₁. For example, but not as a limitation, the second time period may be two weeks; and may be predefined and/or changeable by a user of user device 120. Further, identifier 220 may identify the media content as being in normal operating mode, if the media content has been used on user device 120 or the user account associated with the owner and/or operator of user device 120 within the second time period Tₚ₂.

Scheduler 230 may be configured to analyze and/or check the usage history for the media content that is identified as being hibernating at a first predetermined time interval Tᵢ₁. For example, but not as a limitation, scheduler 230 may check the usage history for the hibernating media content every 24 hours, and determine whether the hibernating media content has been used or not. Scheduler 230 may determine a remaining amount of time until the hibernating media content is deemed to be sleeping media content, based on the usage history of the hibernating media content. Further, scheduler 230 may be configured to analyze and/or check the usage history for the media content that is identified as normal media content at a second predetermined time interval Tᵢ₂, that may be longer than the first predetermined time interval Tᵢ₁. For example, but not as a limitation, user device 120 may check the usage history for the normal media content every 72 hours or once a week. Scheduler 230 may further determine a remaining amount of time until the normal media content may be deemed to be sleeping media content.

Receiver 240 may be configured to receive user input that may include at least one of a desired price for the identified sleeping media content or a desired sales format for the identified sleeping media content. Further, as non-limiting examples, the sales format may include at least one of an auction, a direct transaction between another user device and server 130, a resale or refund transaction between server 130 and a service provider that corresponds to the sleeping media content, an exchange of the sleeping media content for other media content or reward points.

Further, receiver 240 may be configured to receive, from server 130, a notification regarding a result of the transaction of the sleeping media content and a reward corresponding to the price. For example, the reward may include at least one of cash, game currency, reward points or user rights for other media content.

Transmitter 250 may be configured to transmit, to server 130, an offer to sell the sleeping media content. In some embodiments, the offer may include at least one of the desired price for the sleeping media content and/or the desired sales format for the sleeping media content. Further, in some embodiments, the offer may include at least one of content information describing the sleeping media content, such as game currency, a game character, a game level or a game item; an identifier of user device 120; or user's account authenticated on user device 120. In some embodiments, transmitter 250 may be configured to transmit the offer to sell the sleeping media content to server 130 automatically without receiving an instruction or user input to transmit the offer.

Database 260 may be configured to store media content, user rights to use the media content, and data regarding usage history for the media content. For example, database 260 may be a cloud database, an external memory, or an internal memory which is communicatively coupled to user device 120.

Thus, FIG. 2 shows an example user device 120 by which at least portions of a media content transaction may be implemented, in accordance with various embodiments described herein.

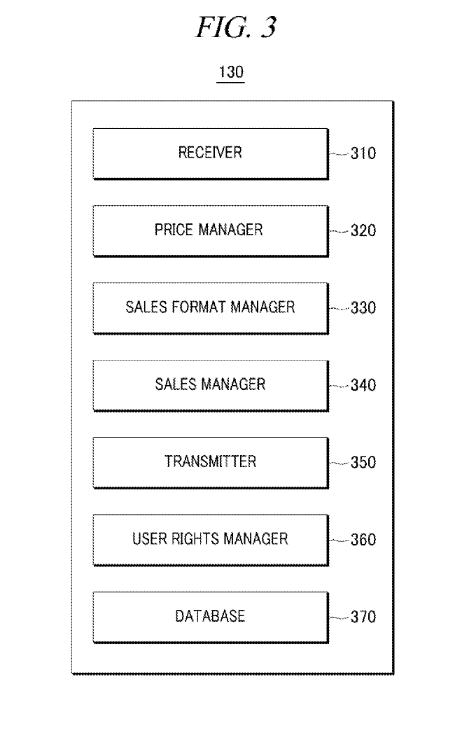

FIG. 3 shows an example server by which at least portions of a media content transaction may be implemented, in accordance with various embodiments described herein. As depicted in FIG. 3, server 130 may include a receiver 310, a price manager 320, a sales format manager 330, a sales manager 340, a transmitter 350, a user rights manager 360, and a database 370. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of receiver 310, price manager 320, sales format manager 330, sales manager 340, transmitter 350, user rights manager 360, and database 370 may be included in an instance of an application hosted on server 130.

Receiver 310 may be configured to receive, from user device 120, a request to sell sleeping media content that is associated with a user's account of user device 120. In some embodiments, the request may include a desired price for the sleeping media content and/or a desired sales format for the sleeping media content. Further, receiver 310 may receive, from user device 120, an instruction to execute the desired sales format, along with the request to sell the sleeping media content. In some embodiments, the request may include at least one of content information describing the sleeping media content, such as game currency, a game character, a game level or a game item; an identifier of user device 120; or the user's account of user device 120.

Price manager 320 may be configured to determine a price for the sleeping media content. In some embodiments, price manager 320 may identify the desired price included in the sales request as the price for the sleeping media content. In some other embodiments, price manager 320 may estimate the price for the sleeping media content based on the desired price and/or the content information that is included in the sales request. For example, price manager 320 may estimate the price for sleeping game character based on at least one of game currency that the sleeping game character has, game items that are equipped with the sleeping game character, or a game level of the sleeping game character. Thus, in some embodiments, price manager 320 may determine a transaction price for the sleeping media content as the user's asking price (e.g., the desired price) itself. Alternatively, in some other embodiments, price manager 320 may calculate or estimate a transaction price for the sleeping media content based on the value of the content and/or the user's asking price.

Sales format manager 330 may be configured to determine a sales format for the sleeping media content as one of conducting a direct transaction between another user device and server 130, conducting a resale or refund transaction between server 130 and a service provider that corresponds to the sleeping media content, conducting an auction or an exchange of the sleeping media content for other media content or reward points. In some embodiments, sales format manager 330 may be configured to identify a sales format for the sleeping media content as the desired sales format which is included in the sales request.

Sales manager 340 may be configured to sell the sleeping media content based on the determined or estimated price and the determined sales format. For example, sales manager 340 may conduct a transaction between server 130 and another user device on behalf of the user, e.g., owner/operator of user device 120. Sales manager 340 may transmit, to the other user device, user rights to use the sleeping media content, and receive, from the other user device, at least one of game currency, or reward points that correspond to the estimated price. As another example, sales manager 340 may conduct a transaction between server 130 and a service provider that provides the sleeping media content on behalf of the user, e.g., owner/operator of user device 120. Sales manager 340 may return, to the service provider, user rights that are assigned to user device 120 or to a user account for an owner/operator of user device 120 to use the sleeping media content, and receive, from the service provider, at least one of another media content, game currency, or reward points that correspond to the estimated price. For another example, sales manager 340 may conduct an auction to sell the sleeping media content between multiple user devices on behalf of the user, e.g., owner/operator of user device 120 by executing well-known web or internet-based auction processes to sell the sleeping media content.

Transmitter 350 may be configured to transmit, to user device 120, a notification regarding a result of the sale of the sleeping media content and a reward corresponding to the estimated price. For example, the result may include an identifier of the sold media content or the executed sales format. Further, the reward may include at least one of cash, game currency, reward points or user rights for other media content.

User rights manager 360 may be configured to retrieve, from user device 120, user rights to use or play the sleeping media content when the sleeping media content is sold. Further, user rights manager 360 may be configured to transmit, to another device that purchased the sleeping media content, user rights to use or play the sleeping media content.

Database 370 may be configured to register the sleeping media content as media content that is being actively used or has been recently used. Further, database 370 may be configured to store the content information in association with the user's account.

Thus, FIG. 3 shows an example server 130 by which at least portions of a media content transaction may be implemented, in accordance with various embodiments described herein.

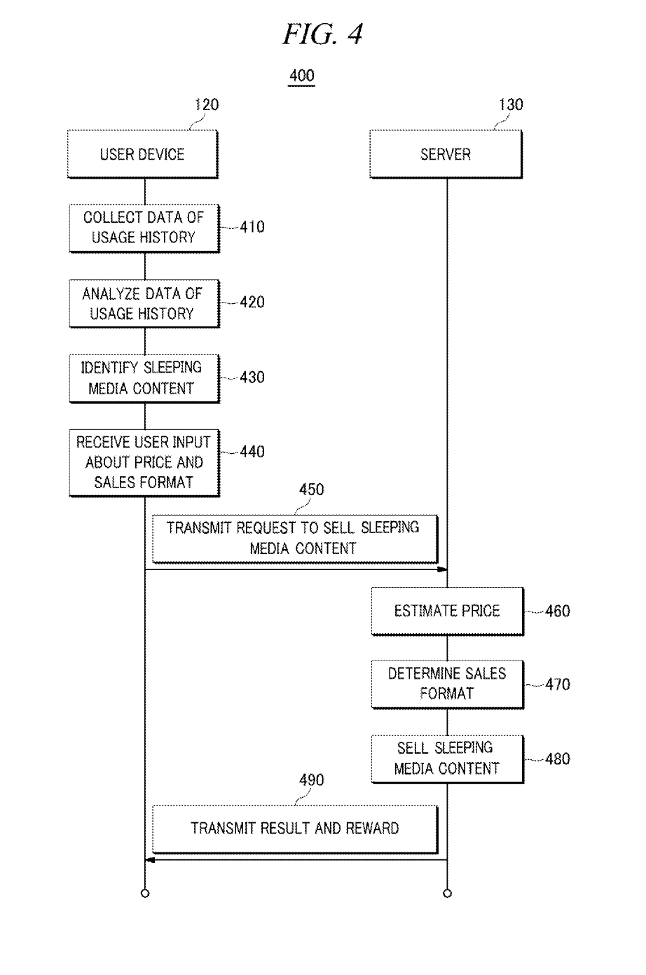

FIG. 4 shows an example processing flow 400 of operations by which at least portions of a media content transaction may be implemented, in accordance with various embodiments described herein. The operations of processing flow 400 may be implemented in system configuration 10 including user device 120 and server 130, as illustrated in FIG. 1. Processing flow 400 may include one or more operations, actions, or functions as illustrated by one or more blocks 410, 420, 430, 440, 450, 460, 470, 480 and/or 490. Although illustrated as discrete blocks, various blocks may be divided into additional blocks, combined into fewer blocks, or eliminated, depending on the desired implementation. Processing may begin at block 410.

Block 410 (Collect Data of Usage History) may refer to user device 120 collecting data regarding usage history for media content that is associated with a user's account that is authenticated on user device 120. For example, but not as a limitation, the data regarding usage history for media content may include at least one of a play history that may include dates and/or times on which the media content has been used or played, an amount of time that the media content has been used or played, the most recent date on which the media content was used or played, or a number of times for the media content has been used or played. As non-limiting examples, the media content may include at least one of images, videos, music, apps, electronic book content, game currency, game characters, or game items associated with the game characters. Processing may proceed from block 410 to block 420.

Block 420 (Analyze Data of Usage History) may refer to user device 120 analyzing the collected data regarding usage history for the media content. For example, user device 120 may check the most recent date on which the media content was used or played on user device 120 or in connection with a user account associated with the owner and/or operator of user device 120. Processing may proceed from block 420 to block 430.

Block 430 (Identify Sleeping Media Content) may refer to user device 120 identifying the media content to be sleeping, based on the usage history for the media content. In some embodiments, user device 120 may identify the media content as sleeping if the media content has not been used on user device 120 or in connection with a user account associated with the owner and/or operator of user device 120 for more than a predetermined time period, which may be a setting made in connection with a user account associated with the owner and/or operator of user device 120. For example, but not as a limitation, the predetermined time period may be set to be, e.g., a month; and may be predefined and/or changeable by a user of user device 120. Processing may proceed from block 430 to block 440.

Block 440 (Receive User Input about Price and Sales Format) may refer to user device 120 receiving user input that may include a desired price for the identified sleeping media content and a desired sales format for the identified sleeping media content. As non-limiting examples, the sales format may include at least one of an auction, a direct transaction between another user device and server 130, a resale or refund transaction between server 130 and a service provider that corresponds to the sleeping media content, an exchange of the sleeping media content for other media content or reward points. Processing may proceed from block 440 to block 450.

Block 450 (Transmit Request to Sell Sleeping Media Content) may refer to user device 120 transmitting, to server 130, a request to sell the identified sleeping media content. In some embodiments, the request may include at least one of the desired price for the sleeping media content and/or the sales format for the sleeping media content. Further, in some embodiments, the request may include at least one of content information describing the sleeping media content, such as game currency, a game character or a game item; an identifier of user device 120; or user's account authenticated on user device 120. Processing may proceed from block 450 to block 460.

Block 460 (Estimate Price) may refer to server 130 estimating a price for the sleeping media content. In some embodiments, server 130 may estimate the price for the sleeping media content based on the desired price and/or the content information that is included in the sales request transmitted at block 450. For example, server 130 may estimate the price for sleeping game character based on at least one of game currency that the sleeping game character has, game items that are equipped with the sleeping game character, or a game level of the sleeping game character. In some other embodiments, server 130 may determine the desired price included in the sales request transmitted at block 450 as a price for the sleeping media content. Processing may proceed from block 460 to block 470.

Block 470 (Determine Sales Format) may refer to server 130 determining a sales format for the sleeping media content as one of conducting a direct transaction between another user device and server 130, conducting a refund or resale transaction between server 130 and a service provider that corresponds to the sleeping media content, conducting an auction or an exchange of the sleeping media content for other media content or reward points. In some embodiments, server 130 may determine a sales format for the sleeping media content as the desired sales format which is included in the sales request transmitted at block 450. Processing may proceed from block 470 to block 480.

Block 480 (Sell Sleeping Media Content) may refer to server 130 selling the sleeping media content based on the estimated price and the determined sales format. For example, server 130 may conduct a transaction between server 130 and another user device on behalf of the user, e.g., owner/operator of user device 120. Server 130 may transmit, to the other user device, user rights to use the sleeping media content, and may receive, from the other user device, at least one of game currency, or reward points that correspond to the estimated price. For another example, server 130 may conduct a transaction between server 130 and a service provider that provides the sleeping media content on behalf of the user, e.g., owner/operator of user device 120. Server 130 may return, to the service provider, user rights that are assigned to user device 120 or to a user account for an owner/operator of user device 120 to use the sleeping media content, and may receive, from the service provider, at least one of another media content, game currency, or reward points that correspond to the estimated price. For another example, server 130 may conduct an auction to sell the sleeping media content between multiple user devices. Processing may proceed from block 480 to block 490.

Block 490 (Transmit Result and Reward) may refer to server 130 transmitting, to user device 120, a notification regarding a result of the sale of the sleeping media content and a reward corresponding to the estimated price. For example, the result may include an identifier of the sold media content and/or the executed sales format. Further, the reward may include at least one of cash, game currency, reward points or user rights for other media content.

Thus, FIG. 4 shows an example processing flow 400 of operations by which at least portions of a media content transaction may be implemented, in accordance with various embodiments described herein.

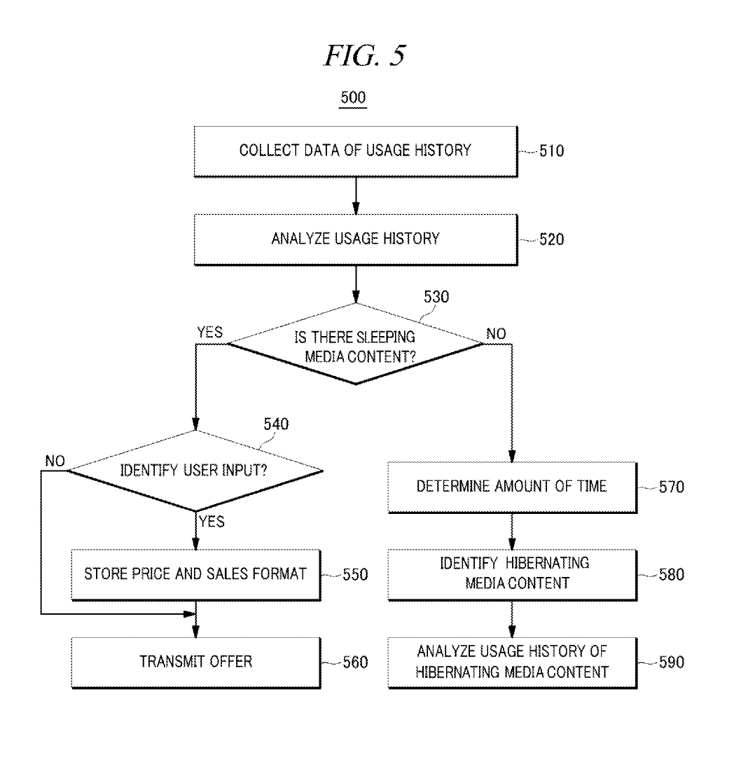

FIG. 5 shows another example processing flow 500 of operations by which at least portions of a media content transaction may be implemented, in accordance with various embodiments described herein. The operations of processing flow 500 may be implemented in system configuration 10 including user device 120 and server 130, as illustrated in FIG. 1. Processing flow 500 may include one or more operations, actions, or functions as illustrated by one or more blocks 510, 520, 530, 540, 550, 560, 570, 580 and/or 590. Although illustrated as discrete blocks, various blocks may be divided into additional blocks, combined into fewer blocks, or eliminated, depending on the desired implementation. Processing may begin at block 510.

Block 510 (Collect Data of Usage History) may refer to user device 120 collecting data regarding usage history for media content that is associated with a user's account that is authenticated on user device 120. For example, but not as a limitation, the data regarding usage history for media content may include at least one of a play history that may include dates and/or times on which the media content has been used or played, an amount of time that the media content has been used or played, the most recent date on which the media content was used or played, or a number of times for the media content has been used or played. As non-limiting examples, the media content may include at least one of images, videos, music, apps, electronic book content, game currency, game characters, or game items associated with the game characters. Processing may proceed from block 510 to block 520.

Block 520 (Analyze Usage History) may refer to user device 120 analyzing the collected data regarding usage history for the media content. For example, user device 120 may check the most recent date on which the media content was used or played on user device 120 or in connection with a user account associated with the owner and/or operator of user device 120. Processing may proceed from block 520 to block 530.

Block 530 (Identify whether Media Content is Sleeping) may refer to user device 120 identifying whether the media content is sleeping media content, based on the data regarding the usage history for the media content. In some embodiments, user device 120 may identify the media content as being sleeping if the media content has not been used on user device 120 or in connection with the user account associated with the owner and/or operator of user device 120 for more than first time period Tₚ₁ predetermined for that purpose. For example, but not as a limitation, the first predetermined time period Tₚ₁ may be set to be a month. If user device 120 identifies the media content as being sleeping, processing may proceed to block 540, while otherwise, processing may proceed to block 570.

Block 540 (Identify User Input) may refer to user device 120 identifying whether a user input that may include at least one of a desired price for the identified sleeping media content and/or a desired sales format for the identified sleeping media content is received. As non-limiting examples, the sales format may include at least one of an auction, a direct transaction between another user device and server 130, a resale or refund transaction between server 130 and a service provider that corresponds to the sleeping media content, an exchange of the sleeping media content for other media content or reward points. If user device 120 identifies the received user input, processing may proceed to block 550, while otherwise, processing may proceed to block 560.

Block 550 (Store Price and Sales Format) may refer to user device 120 storing, in a database, the desired price for the sleeping media content and the desired sales format for the sleeping media content that are included in the user input. Processing may proceed from block 550 to block 560.

Block 560 (Transmit Offer) may refer to user device 120 transmitting, to server 130, an offer to sell the sleeping media content. In some embodiments, the offer may include at least one of the desired price for the sleeping media content or the desired sales format for the sleeping media content.

Block 570 (Determine Amount of Time) may refer to user device 120 determining a remaining amount of time until the media content that is identified as not being sleeping at block 530 is deemed to be sleeping media content, based on the data regarding the usage history for the media content. Processing may proceed from block 570 to block 580.

Block 580 (Identify Hibernating Media Content) may refer to user device 120 identifying the media content to be hibernating if the media content that is identified as not being sleeping at block 530 has not been used on user device 120 or in connection with the user account associated with the owner and/or operator of user device 120 for more than second time period Tₚ₂ predetermined for that purpose. The second predetermined time period Tₚ₂ may be shorter than the first time period Tₚ₁. For example, but not as a limitation, the second time period Tₚ₂ may be two weeks. That is, the hibernating media content may be preliminary sleeping content that may be imminently identified as being sleeping. Processing may proceed from block 580 to block 590.

Block 590 (Analyze Usage History of Hibernating Media Content) may refer to user device 120 analyzing the usage history for the media content that is identified as the hibernating media content at a predetermined time interval. For example, user device 120 may check the usage history for the hibernating media content every 24 hours, and determine whether the hibernating media content has been used or not.

Thus, FIG. 5 shows another example processing flow 500 of operations by which at least portions of a media content transaction may be implemented, in accordance with various embodiments described herein.

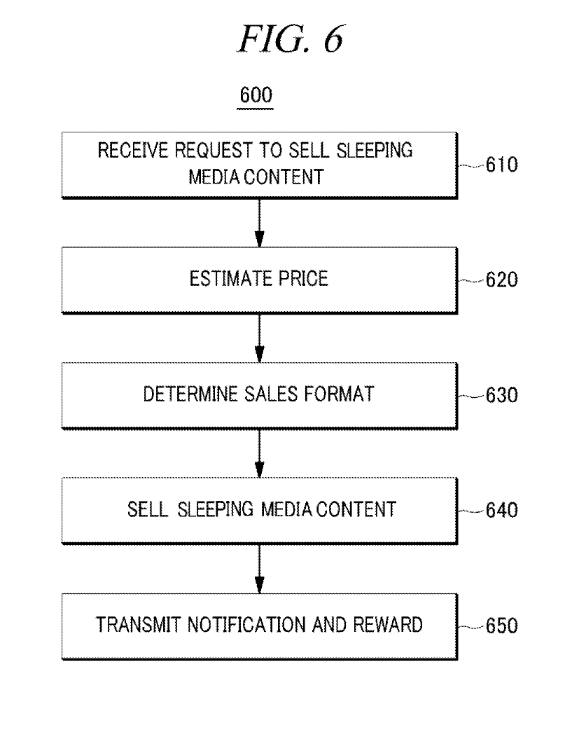

FIG. 6 shows still another example processing flow 600 of operations by which at least portions of a media content transaction may be implemented, in accordance with various embodiments described herein. The operations of processing flow 600 may be implemented in system configuration 10 including user device 120 and server 130, as illustrated in FIG. 1. Processing flow 600 may include one or more operations, actions, or functions as illustrated by one or more blocks 610, 620, 630, 640 and/or 650. Although illustrated as discrete blocks, various blocks may be divided into additional blocks, combined into fewer blocks, or eliminated, depending on the desired implementation. Processing may begin at block 610.

Block 610 (Receive Request to Sell Sleeping Media Content) may refer to server 130 receiving, from user device 120, a request to sell sleeping media content that is associated with a user's account of user device 120. In some embodiments, the request may include a desired price for the sleeping media content and/or a desired sales format for the sleeping media content. In some embodiments, the request may include content information describing the sleeping media content, such as game currency, a game character, a game level or a game item. Processing may proceed from block 610 to block 620.

Block 620 (Estimate Price) may refer to server 130 estimating a price for the sleeping media content. In some embodiments, server 130 may identify the desired price included in the sales request received at block 610 as the price for the sleeping media content. In some other embodiments, server 130 may estimate the price for the sleeping media content based on the desired price and/or the content information that is included in the sales request received at block 610. For example, server 130 may estimate the price for sleeping game character based on at least one of game currency that the sleeping game character has, game items that are equipped with the sleeping game character, or a game level of the sleeping game character. Thus, a transaction price for the sleeping media content may be determined as the user's asking price (e.g., the desired price) itself. Alternatively, the transaction price for the sleeping media content may be estimated based on the value of the content and/or the user's asking price. Processing may proceed from block 620 to block 630.

Block 630 (Determine Sales Format) may refer to server 130 determining a sales format for the sleeping media content, based on the desired sales format that is included in the sales request received at block 610. For example, the sales format may include one of conducting a direct transaction between another user device and server 130, conducting a resale or refund transaction between server 130 and a service provider that corresponds to the sleeping media content, conducting an auction or an exchange of the sleeping media content for other media content or reward points. Processing may proceed from block 630 to block 640.

Block 640 (Sell Sleeping Media Content) may refer to server 130 selling the sleeping media content based on the estimated price and the determined sales format. For example, server 130 may conduct a transaction between server 130 and another user device on behalf of the user, e.g., owner/operator of user device 120. Server 130 may transmit, to the other user device, user rights to use the sleeping media content, and may receive, from the other user device, at least one of cash, game currency, or reward points that correspond to the estimated price. As another example, server 130 may conduct a transaction between server 130 and a service provider that provides the sleeping media content on behalf of the user, e.g., owner/operator of user device 120. Server 130 may return, to the service provider, user rights that are assigned to user device 120 or to a user account for an owner/operator of user device 120 to use the sleeping media content, and may receive, from the service provider, at least one of another media content, cash, game currency, or reward points that correspond to the estimated price. As another example, server 130 may conduct an auction to sell the sleeping media content between multiple user devices on behalf of the user, e.g., owner/operator of user device 120 by executing well-known web or internet-based auction processes to sell the sleeping media content. Processing may proceed from block 640 to block 650.

Block 650 (Transmit Notification and Reward) may refer to server 130 transmitting, to user device 120, a notification regarding a result of the sale of the sleeping media content and a reward corresponding to the estimated price. For example, the result may include an identifier of the sold media content or the executed sales format. Further, the reward may include at least one of cash, game currency, reward points or user rights for other media content.

Thus, FIG. 6 shows still another example processing flow 600 of operations by which at least portions of a media content transaction may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

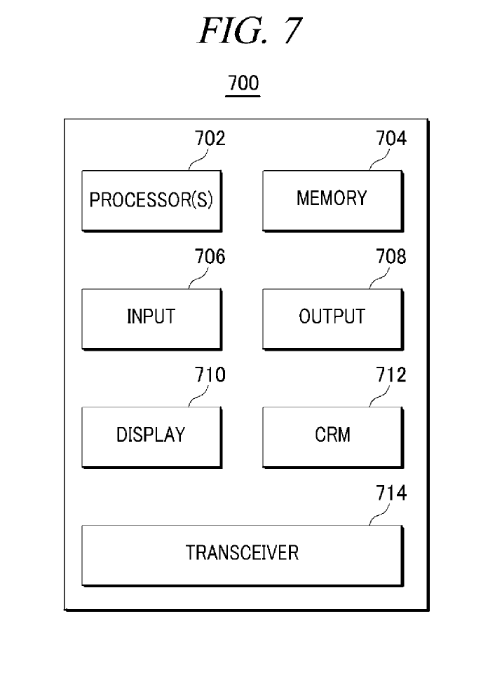

FIG. 7 shows an computing embodiment, in which any of the processes and sub-processes of a media content transaction may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 700 may typically include, at least, one or more processors 702, a system memory 704, one or more input components 706, one or more output components 708, a display component 710, a computer-readable medium 712, and a transceiver 714.

Processor 702 may refer to, e.g., a microprocessor, a microcontroller, a digital signal processor, or any combination thereof.

Memory 704 may refer to, e.g., a volatile memory, non-volatile memory, or any combination thereof. Memory 704 may store, therein, an operating system, an application, and/or program data. That is, memory 704 may store executable instructions to implement any of the functions or operations described above and, therefore, memory 704 may be regarded as a computer-readable medium.

Input component 706 may refer to a built-in or communicatively coupled keyboard, touch screen, or telecommunication device. Alternatively, input component 706 may include a microphone that is configured, in cooperation with a voice-recognition program that may be stored in memory 704, to receive voice commands from a user of computing device 700. Further, input component 706, if not built-in to computing device 700, may be communicatively coupled thereto via short-range communication protocols including, but not limitation, radio frequency or Bluetooth.

Output component 708 may refer to a component or module, built-in or removable from computing device 700, that is configured to output commands and data to an external device.

Display component 710 may refer to, e.g., a solid state display that may have touch input capabilities. That is, display component 710 may include capabilities that may be shared with or replace those of input component 706.

Computer-readable medium 712 may refer to a separable machine readable medium that is configured to store one or more programs that embody any of the functions or operations described above. That is, computer-readable medium 712, which may be received into or otherwise connected to a drive component of computing device 700, may store executable instructions to implement any of the functions or operations described above. These instructions may be complimentary or otherwise independent of those stored by memory 704.

Transceiver 714 may refer to a network communication link for computing device 700, configured as a wired network or direct-wired connection. Alternatively, transceiver 714 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A user device, comprising:
a collector configured to collect data regarding usage history for media content associated with a user's account;
an identifier configured to identify whether the respective media content is sleeping; and
a scheduler configured to determine, if the media content is not identified as being sleeping, an amount of time until the respective media content may be identified as being sleeping, based on the usage history.

2. The user device of claim 1, further comprising:
a transmitter configured to transmit an offer to sell the identified sleeping media content to a server,
wherein the offer includes a price for the identified sleeping media content.

3. The user device of claim 1, wherein the respective media content includes at least one of game currency, a game character or a game item associated with the game character.

4. The user device of claim 1, wherein the identifier is further configured to identify whether the media content identified as not being sleeping is hibernating.

5. The user device of claim 4, wherein the scheduler is further configured to:
analyze the usage history for the media content identified as being hibernating at a first predetermined time interval, and
analyze the usage history for normal media content at a second predetermined time interval longer than the first predetermined time interval.

6. The user device of claim 4, wherein the identifier is configured to identify the media content as being sleeping, if the media content has not been used for a first time period, and
wherein the identifier is configured to identify the media content as being hibernating, if the media content has not been used for a second time period shorter than the first time period.

7. The user device of claim 2, further comprising:
a receiver configured to receive a user input that includes the price for the identified sleeping media content.

8. The user device of claim 2, wherein the offer to sell the identified sleeping media content is transmitted from the user device to the server automatically.

9. A server, comprising:
a receiver configured to receive, from a user device, a request to sell sleeping media content;
a price manager configured to estimate a price for the sleeping media content; and
a database configured to register the sleeping media content as used media content.

10. The server of claim 9, wherein the sleeping media content is associated with a user's account.

11. The server of claim 9, wherein the sleeping media content includes at least one of game currency, a game character or a game item associated with the game character.

12. The server of claim 11, wherein the price manager is configured to estimate the price of the game character based at least in part on at least one of the game currency which the game character has, the game item equipped with the game character, or a game level of the game character.

13. The server of claim 9, further comprising:
a sales format manager configured to determine a sales format for the sleeping media content.

14. The server of claim 13, wherein the sales format manager is configured to determine the sales format for the sleeping media content that includes one of:
conducting a transaction between the server and another user device,
conducting a transaction between the server and a service provider corresponding to the sleeping media content, or
conducting an auction.

15. The server of claim 13, wherein the receiver is further configured to receive, from the user device, an instruction to execute the sales format.

16. The server of claim 13, further comprising:
a sales manager configured to sell the sleeping media content based at least in part on the estimated price and the determined sales format.

17. The server of claim 16, further comprising:
a transmitter configured to transmit, to the user device, a notification regarding a result of the sale of the sleeping media content and a reward corresponding to the estimated price,
wherein the reward includes at least one of cash, game currency, reward points or another media content.

18. A system, comprising:
a user device configured to:
collect data regarding usage history for game content, and
identify whether the game content is sleeping based on the usage history; and
a server configured to:
receive, from the user device, a request to sell the sleeping game content,
estimate a price for the sleeping game content, and
register the sleeping game content as used game content.

19. The system of claim 18, wherein the user device is further configured to identify non-sleeping game content as hibernating game content.

20. The system of claim 19, wherein the user device is further configured to:
analyze the usage history for the hibernating game content at a first predetermined time interval, and
analyze the usage history for normal content at a second predetermined time interval longer than the first predetermined time interval.
